(19) United States
(12) Patent Application Publication
(10) Pub. No.: US 2006/0013093 A1
(43) Pub. Date: Jan. 19, 2006

(54) Content recording apparatus

(75) Inventor: Atsuhiko Tatsuda, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-City (JP)

(21) Appl. No.: 11/179,549

(22) Filed: Jul. 13, 2005

(30) Foreign Application Priority Data
Jul. 14, 2004 (JP) 2004-207109

(51) Int. Cl. G11B 5/09

(52) U.S. Cl. 369/53.1; 369/53.2; 369/47.1

(57) ABSTRACT

A content recording apparatus adapted to the surveillance camera system. A HDD (Hard Disk Drive) cyclically records an MPEG-PS (Program Stream) and an INDEX data into an MPEG file and an INDEX file in a hard disk. When a power is provided, a CPU determines whether last recording operation by the HDD is abnormally ended referring to a managing file or not. If a determination result is affirmative, the CPU reads out the MPEG-PS from each a frame of the MPEG file, and reads out the INDEX data from each 24 bytes of the INDEX file. If an error of the hard disk causes a failure of a reading operation, the CPU executes a clear process. As a result, the error of the hard disk is restored. If the reading operation succeeds, the CPU detects a point of discontinuous time of the MPEG-PS or the INDEX file. When the error is restored or the point of discontinuous time is detected, a normal recording operation is started.

### CROSS REFERENCE TO RELATED APPLICATIONS

This present application claims the benefit of Japanese patent application number 2004-207109, filed in Japan on Jul. 14, 2004, the subject matter of which is hereby incorporated herein reference.

### BACKGROUND OF THE INVENTION

1. Field of the Invention

This present invention relates to a content recording apparatus. More especially, the present invention relates to a content recording apparatus adapted to a surveillance camera system, and is recording content data into a recording medium.

2. Description of the Related Art

In such a kind of a conventional content recording apparatus, a recording operation is started, TMAP information according to the DVD-VR standard is periodically written in a power failure measuring file on hard disk. When a recording suspending request is issued, the TMAP information recorded in the power failure measuring file is cleared, the recording operation is suspended. Therefore, if the recording operation is abnormally ended due to the power failure, the TMAP information remains without being cleared in the power failure measuring file. A determination process determined whether the power failure occurred during the recording operation or not and a restoring process restoring in the state immediately before the power failure occurred is executed referring to the power failure measuring file.

However, in the HDD, an error might occur in a sector accessed at abnormal termination time, when the recording operation is abnormally ended due to the power failure etc. The restoring process (clear process) is generally executed on the error sector at next recording operation, and the error sector is restored to the normal sector that can be recorded. But if the restoring process is executed at the recording operation, that is, both the clear process and a recording process are executed at the same time, and then a load of the HDD increases and the recording process might fail.

### SUMMERY OF THE INVETION

According to the preferred embodiments, a content recording apparatus, its program, and its method are provided, and capable of reducing the load in the recording process.

If the error occurred in the recording medium by ending abnormally due to the power failure etc, the error is restored in response to a power supply and then the recording operation is begun. Unless the error occurred in the recording medium though it was abnormally ended, the point of discontinuous time is detected in response to the power supply and then the recording operation is resumed. As a result, the error need not be restored at the recording operation and the load is reduced.

### BRIEF DESCRIPTION OF THE DRAWINGS

FIG. 1 is a block diagram showing one embodiment of the present invention;

FIG. 2A is a schematic diagram showing one example of a data structure of the MPEG-PS;

FIG. 2B is a schematic diagram showing one example of a data structure of the INDEX data;

FIG. 3 is a schematic diagram showing one example of a managing file created by a FIG. 1 embodiment;

FIG. 4 is a schematic diagram showing one example of a recording information file created by the FIG. 1 embodiment;

FIG. 5A is a schematic diagram showing one example of a writing state of the managing file;

FIG. 5B is a schematic diagram showing another example of the writing state of the managing file;

FIG. 5C is a schematic diagram showing the other example of the writing state of the managing file;

FIG. 5D is a schematic diagram showing a further example of the writing state of the managing file;

FIG. 6 is a schematic diagram showing a portion of an operation of the FIG. 1 embodiment;

FIG. 7 is a schematic diagram showing one example of a relation between a logical block and a sector allocated on a hard disk;

FIG. 8 is a flowchart showing one portion of the operation of the FIG. 1 embodiment;

FIG. 9 is a flowchart showing another portion of the operation of the FIG. 1 embodiment;

FIG. 10 is a flowchart showing the other portion of the operation of the FIG. 1 embodiment;

FIG. 11 is a flowchart showing a further portion of the operation of the FIG. 1 embodiment;

FIG. 12 is a flowchart showing another portion of the operation of the FIG. 1 embodiment;

FIG. 13 is a flowchart showing the other portion of the operation of the FIG. 1 embodiment;

FIG. 14 is a flowchart showing a further portion of the operation of the FIG. 1 embodiment; and

FIG. 15 is a flowchart showing another portion of the operation of the FIG. 1 embodiment.

### DETAILED DESCRIPTION OF THE PREFERRED EMBODIMENTS

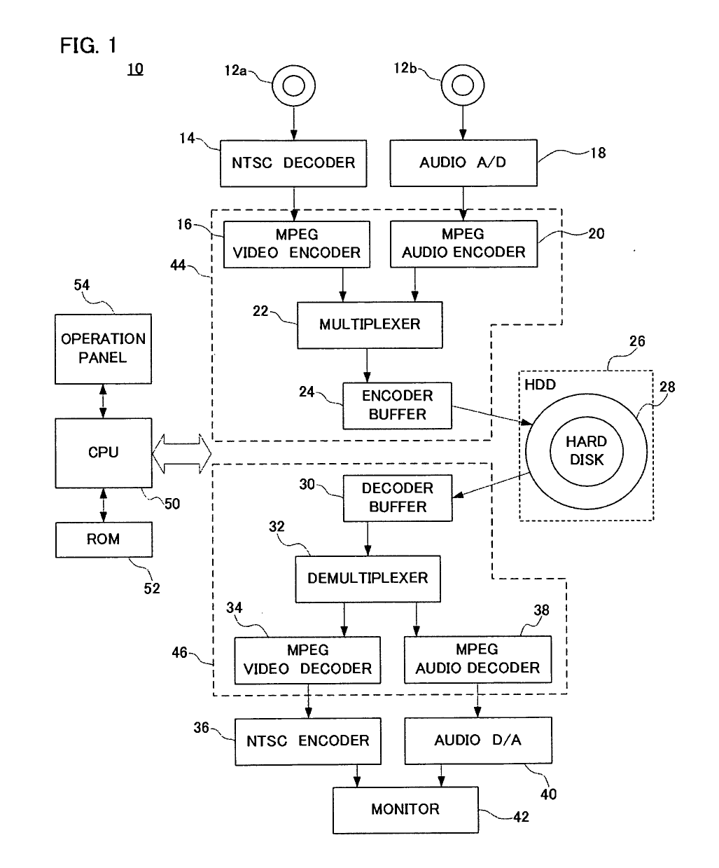

Referring to FIG. 1, a hard disk video recorder 10 of this embodiment includes a video input terminal 12a and a sound input terminal 12b. A composite video signal output from a surveillance camera (not shown) input into the video input terminal 12a, and an audio signal output form the same surveillance camera is input into the audio input terminal 12b. The composite video signal is applied to an NTSC decoder 14, and the audio signal is applied to an audio A/D converter 18.

The NTSC decoder 14 decodes the applied composite video signal, and outputs video data. On the other hand, the audio A/D converter 18 applies an A/D conversion to the audio signal so as to output audio data.

The video data and the audio data are respectively applied to an MPEG video encoder 16 and an MPEG audio encoder 20 that form an MPEG encoder 44. The video data is converted into a video PES (Packetized Elementary Stream) by the MPEG video encoder 16, and the audio data is converted into an audio PES by the MPEG audio encoder 20.

A multiplexer 22 multiplexes the video PES and the audio PES output from the MPEG video encoder 16 and the MPEG audio encoder 20 so as to an MPEG-PS. In addition, the multiplexer 22 creates INDEX data that manages a video frame forming the MPEG-PS. The created MPEG-PS and INDEX data are applied to an HDD (Hard Disk Drive) 26 via an encoder buffer 24. It's noted that the encoder buffer 24 has a capacity capable of storing approximately 30 seconds of the MPEG-PS and INDEX data.

The HDD 26 has a hard disk 28 of the built-in type. The HDD 26 respectively writes the MPEG-PS and the INDEX data into an MPEG file and an INDEX file that are formed in the hard disk 28. INDEX data is always written prior to MPEG-PS. That is, the INDEX data corresponds 10 minutes is written into an INDEX file, and then the MPEG-PS corresponding to these 10 minutes is written into the MPEG file. Thus, a video and a sound or voices perceived by the surveillance camera is recorded into the hard disk 28.

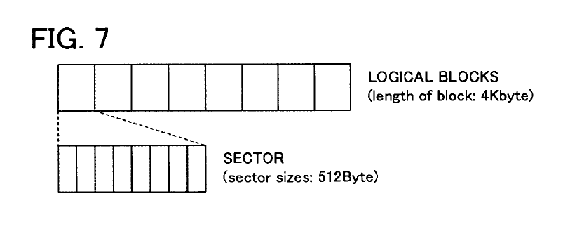

And, referring to the FIG. 7, a recording region of the hard disk 28 is formed by a plurality of logical blocks having each 4 K Bytes of block length. In addition, one logical block is formed with eight sectors where of each has the size in 512 bytes.

When the MPEG-PS stored in the MPEG file is reproduced by the HDD 26, the reproduced MPEG-PS is applied to a de-multiplexer 32 via a decoder buffer 30 that forms an MPEG decoder 46. The decoder buffer 30, too, has a capacity capable of storing the approximately 30 seconds of the MPEG-PS. The de-multiplexer 32 extracts the video PES and the audio PES from the applied MPEG-PS, and respectively applies the extracted video PES and audio PES to an MPEG video decoder 34 and an MPEG audio decoder 38.

The MPEG video decoder 34 decodes the applied video PES so as to create the video data, and applies the created video data to a NTSC encoder 36. The NTSC encoder 36 converts the video data into the composite video signal, and outputs the converted composite video signal to a monitor 42. As a result, the video perceived by the surveillance camera is displayed on a screen.

The MPEG audio decoder 38 decodes the applied audio PES so as to create the audio data. The created audio data is converted into an analog audio signal by an audio D/A converter 40, and the converted audio signal is outputted to the monitor 42. As a result, the sound or voices perceived by the video camera are outputted from a speaker (not shown).

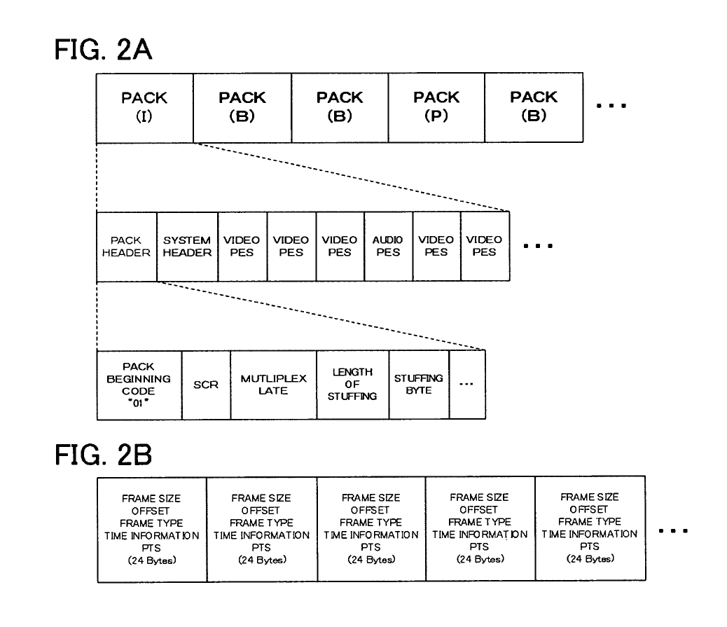

The MPEG-PS stored in the MPEG file has data structure as shown in FIG. 2A, and the INDEX data stored in the INDEX file has data structure as shown in FIG. 2B.

According to FIG. 2A, the MPEG-PS is formed of a plurality of packs; each pack includes a pack header, a system header, video PES packet, and an audio PES packet. A pack beginning code of “01”, SCR (System Clock Reference), amultiplex rate, a length of stuffing, and a stuffing byte etc. are arranged in the pack header in this order.

In an MPEG format, three types, that is, an I picture, a B picture, and a P picture, are defined, and the video PES packet that forms one picture is not to stretch over to a different pack. That is, a plurality of video PES packets that form the I picture in a certain screen are included in the same pack, a plurality of video PES packets that form the B picture in a certain screen are included in the same pack, and a plurality of video PES packets that form the P picture in a certain screen are included in the same pack.

If the I picture is created by each 30 frames, then one GOP (Group Of Pictures) is formed of 30 frames that start from the I picture. If the composite video data outputted from the surveillance camera has a frame rate of 60 fps, then 30 frames that form one GOP corresponds to 0.5 seconds.

It is noted that the audio PES packet is intermittently inserted between the video PES packets so as to be mutually synchronized between a reproduced video and a reproduced sound or voices. In addition, the I picture is an images which an intra-encoding is applied, and each of the B picture and the P picture is an image which an inter-encoding is applied. The picture size (size of the frame) always changes from the difference of the encoding method.

According to the FIG. 2B, the INDEX data is segmented by each 24 bytes, and the segmented 24 bytes allotted to each picture, that is, 24 bytes of INDEX data is mutually related to one picture. The 24 bytes are formed of a frame size indicating a size of a corresponding picture, an MPEG offset indicating an offset from a head of a corresponding MPEG file, a frame type indicating a type of the corresponding picture, a time information indicating a time at which the corresponding picture is created, and a PTS (Presentation Time Stamp) indicating a time period elapsed from a start of recording into the corresponding MPEG file.

It is noted that 4 bytes are allotted to the frame size, 8 bytes are allotted to the MPEG offset, and 4 bytes are allotted to the frame type. In addition, 4 bytes are allotted to the time information, and 4 bytes are allotted to the PTS. By referring to such the INDEX file, it is possible to specify a desired frame from the MPEG file.

In this embodiment, the MPEG-PS and INDEX data are inclusively defined as a “content”.

In the hard disk recorder 10 of this embodiment, even while a normal recording operation is not performed by an operator, the recording is performed. Such the recording operation is defined as a “temporary recording”. At this time, the MPEG-PS is cyclically written into a temporary recording-use MPEG file having a predetermined size. That is, a recording mode is switched between a normal recording mode and a temporary recording mode depending on the presence of the normal recording operation by the operator. In other words, although there is difference between the normal recording mode and the temporary recording mode, as long as the power is being provided, the recording operation is always performed.

Furthermore, in the hard disk recorder 10 of this embodiment, when a designated-portion reproducing operation is not performed by the operator, the MPEG-PS recorded in the hard disk 28 is instantly reproduced. That is, a recording/reproducing of the same MPEG-PS is performed at almost the same time. Such the reproducing operation is defined as a “live reproduction”.

When the designated-portion reproducing operation is performed, the live reproduction is suspended, and the MPEG-PS in the designated portion is reproduced from the hard disk 28. It is noted that the above-described temporary recording or the normal recording is always executed during a time that the designated-portion reproducing operation is performed, too.

In this embodiment, a plurality of the MPEG files each of which has 1 G bytes are formed in advance in the hard disk 28 for the normal recording. A plurality of the INDEX files each of which corresponds to the plurality of the MPEG files, too, are prepared in the hard disk 28.

When the designated MPEG file becomes full, the HDD 26 designates the succeeding MPEG and INDEX files as a recording destination. The following MPEG-PS and INDEX data are respectively recorded into the newly designated MPEG file and the INDEX file. Thus an operation of updating the recording-destination file is defined as a “file stretching”.

It is noted that such file stretching occurs at a time of the reproduction, too. That is, when the whole MPEG-PS is reproduced from the designated MPEG file, the succeeding MPEG file is designated as the reproducing destination, and the MPEG-PS is reproduced from the designated MPEG file.

If the operator makes a special setting, a plurality of the normal recording-use MPEG files are treated as a ring file. In the case, when all the normal recording-use MPEG files become full, an overwriting is executed in the order of the oldest MPEG file. This enables to realize an eternal recording operation even though there is a limit to a time-period of the recorded video and the sound or voices.

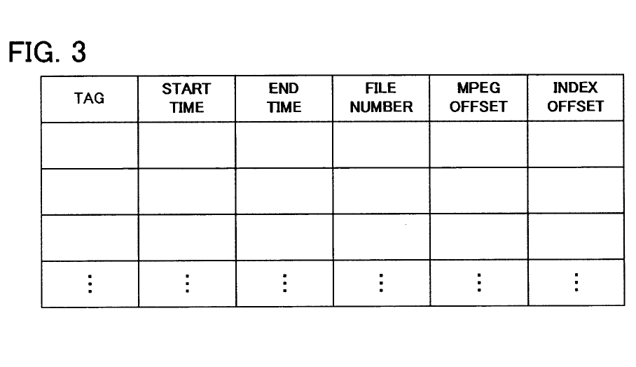

Furthermore, a managing file shown in FIG. 3 is also formed in the hard disk 28. Managing data stored in the managing file is segmented by each 24 bytes, and each 24 bytes represents six columns, that is, a tag (=4 bytes), a starting time(=4 bytes), an ending time(=4 bites), a file number (=4 bytes), the MPEG offset(=4 bytes), and the INDEX offset(=4 bytes).

In the “tag” column, either of identifiers, that is, an identifier REC_START indicating that the normal recording is started, an identifier REC_END indicating that the normal recording is suspended, an identifier MPEG_FILE_START indicating that the writing by the file stretching is started, an identifier MPEG_FILE_END indicating that the writing by the file stretching is ended, and an identifier INVALID indicating an invalid state, is written depending on a situation of the normal recording.

In the “start time” column, a time at which writing into the corresponding MPEG file is started is recorded. In the “end time” column, a time at which writing into the corresponding MPEG file is ended is recorded. In the “file number” column, the file number of the corresponding MPEG file is recorded. In the “MPEG offset” column, a writing starting location of the corresponding MPEG files is recorded. IN the “INDEX offset” column, a location in which the INDEX data corresponding to a frame located in the MPEG offsets is written is recorded.

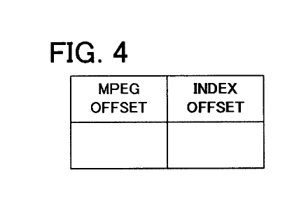

Furthermore, a recording information file shown in FIG. 4 is formed in the hard disk 28. In such recording information file, too, the columns of the “MPEG offset” and “INDEX offset” are formed. In the “MPEG offset” column, a writing location of MPEG-PS at a time of ending the normal recording, and a location in which the INDEX data corresponding to the frame of thus writing locations is written is recorded. By referring to such the recording information file, it is possible to specify the latest frame.

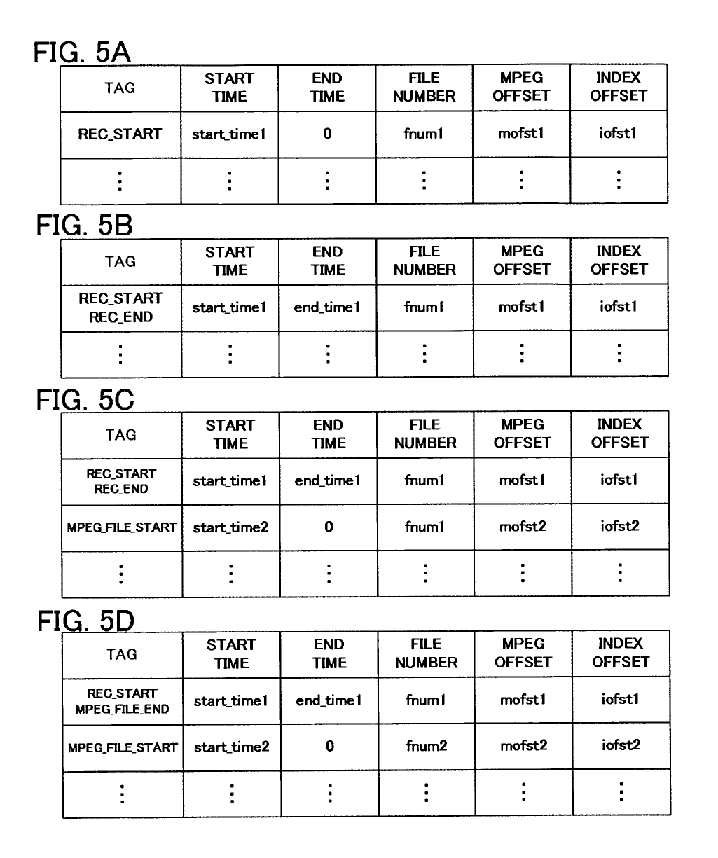

Referring to FIG. 5A-FIG. 5D, the writing operation of the managing file will be described. Upon starting the normal recording, as shown in FIG. 5A, the identifier “REC_START” is written into the “tag” column, and time information start_time1 indicating a starting time of the normal recording is written into the “starting time” column. In addition, a file number fnum1 indicating MPEG file into which the MPEG-PS is written is written into the “file number” column, and anMPEG offset mofset1 indicating a writing starting location of the MPEG-PS, and an INDEX offset iofst1 indicating a writing starting location of the INDEX data are respectively written into the “MPEG offset” column, and the “INDEX offset” column. It is noted that the “ending time” column is remained as “0” (NULL) at this time.

When the normal recording is suspended, as shown in FIG. 5B, the identifier REC_END is additionally written into the “tag” column, and time information end_time1 indicating a suspended time of the normal recording is written into the “end time” column.

When the normal recording is re-started, as shown in FIG. 5C, the succeeding 24 bytes of the managing data is noticed, and REC_START, start_time2, fnum1, mofst2, and iofst2 are respectively written into the columns of “tag”, “start time”, “file number”, “MPEG offset”, and “INDEX offset”.

In addition, if the file stretching occurs in a writing state shown in FIG. 5A, firstly, identifier MPEG_FILE_END is additionally written into the “tag” column, and the time information end_time1 indicating a time at which the file stretching occurs is written into the “end time” column as shown in FIG. 5D. Next, 24 bytes of the succeeding managing file is noticed, and the identifier MPEG_FILE_START, the time information start_time2 indicating a writing starting time into the succeeding MPEG file, the file number fnum2 indicating the succeeding MPEG file, the MPEG offset mofst2 (=0), and the INDEX offset iofst2 (=0) are respectively written into the columns of “tag”, “start time”, “file number”, “MPEG offset”, and “INDEX offset”.

As a result of such managing file being created, it becomes possible to understand in what situation the last normal recording is ended. It is noted that the writing into the managing file is executed only at a time of starting the recording, suspending the recording, and occurring the file stretching so that a load of a CPU 50 and the HDD 26 is extremely small, thus not causing a problem to the recording operation.

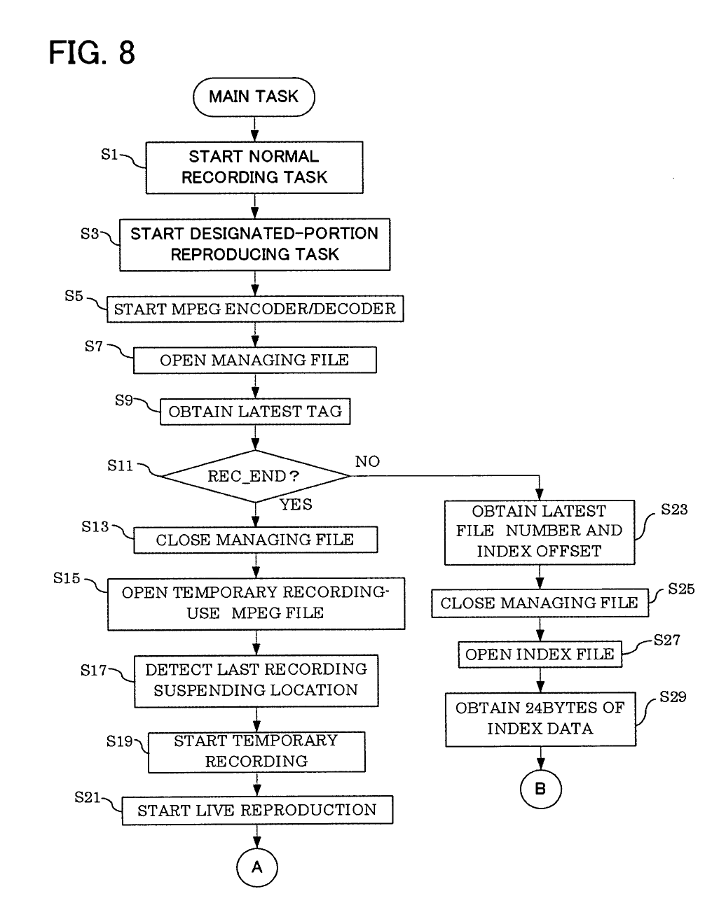

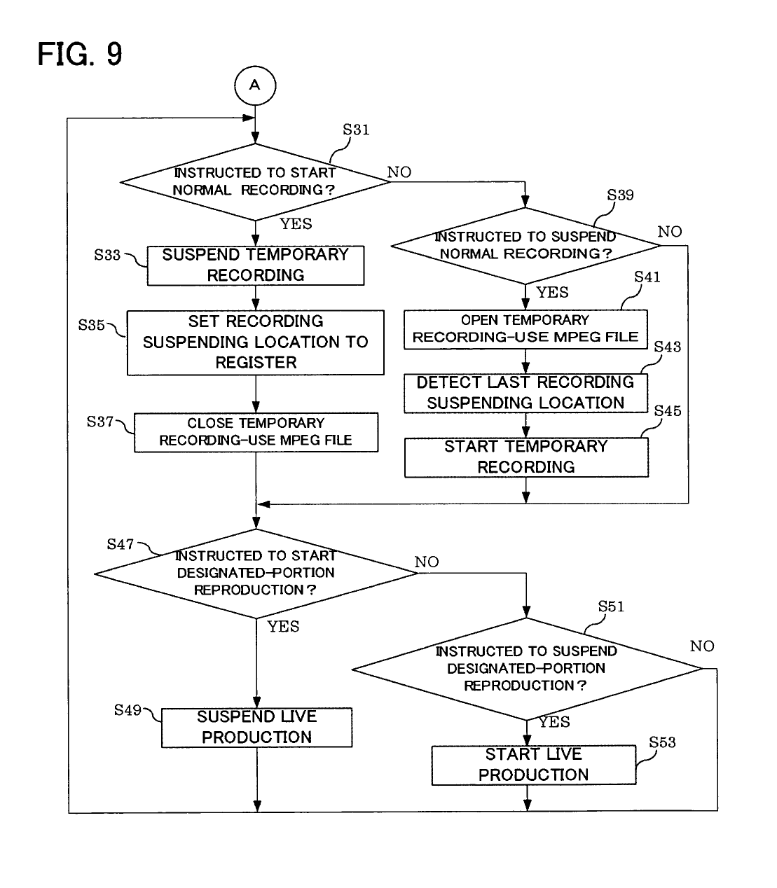

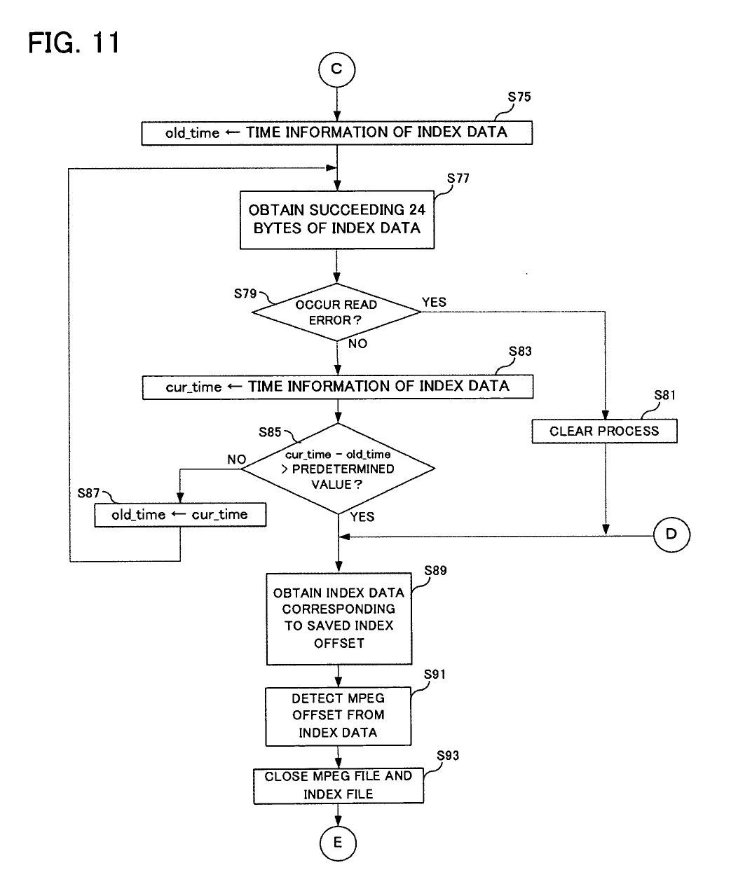

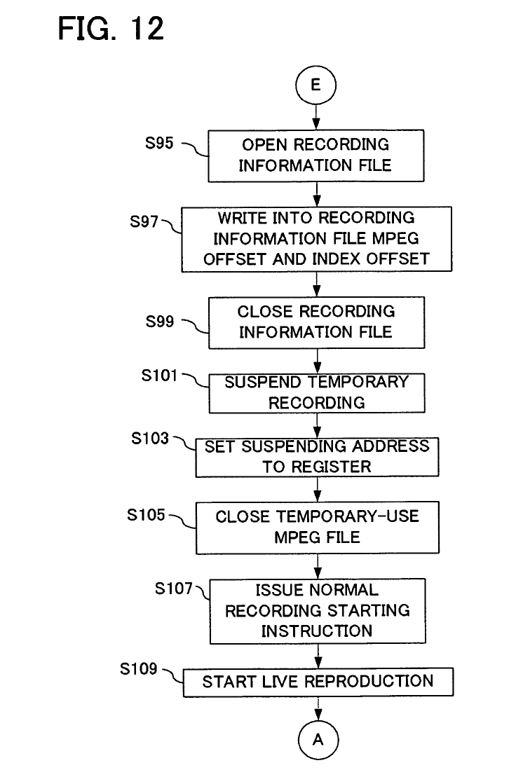

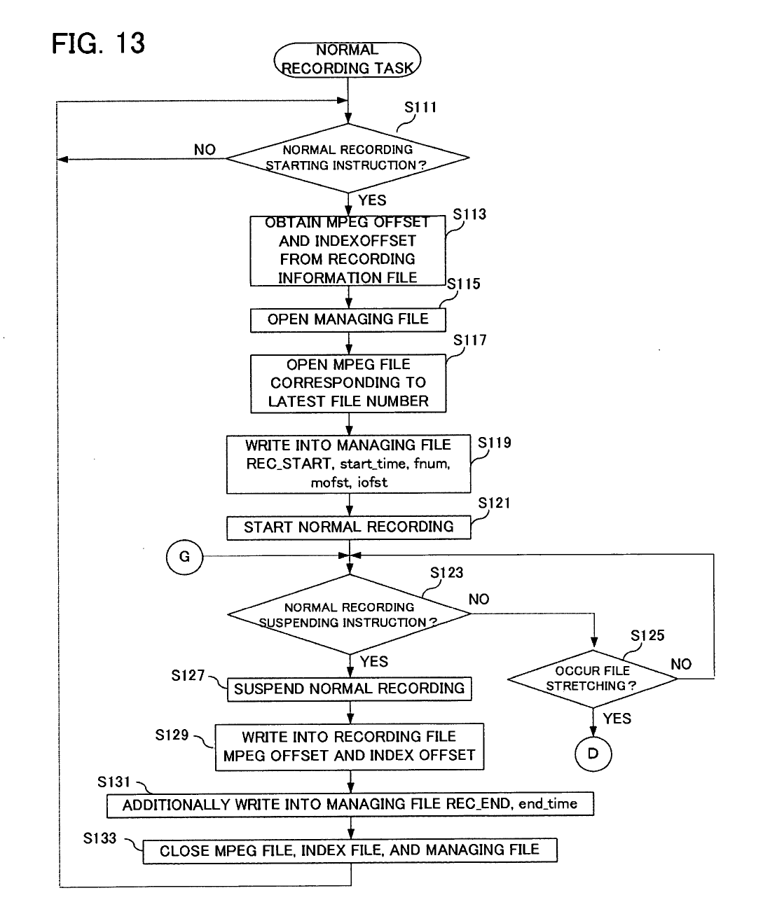

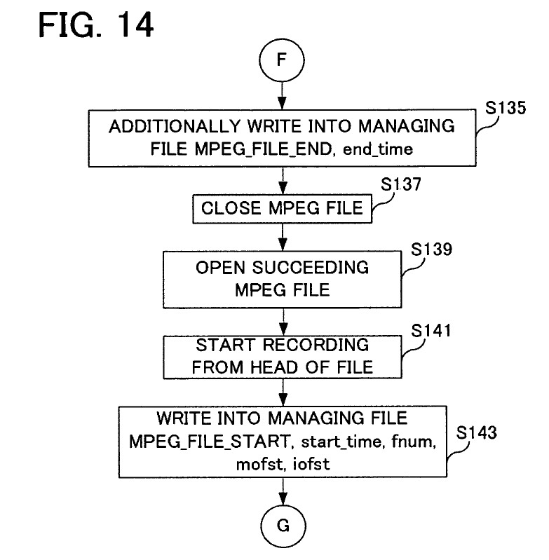

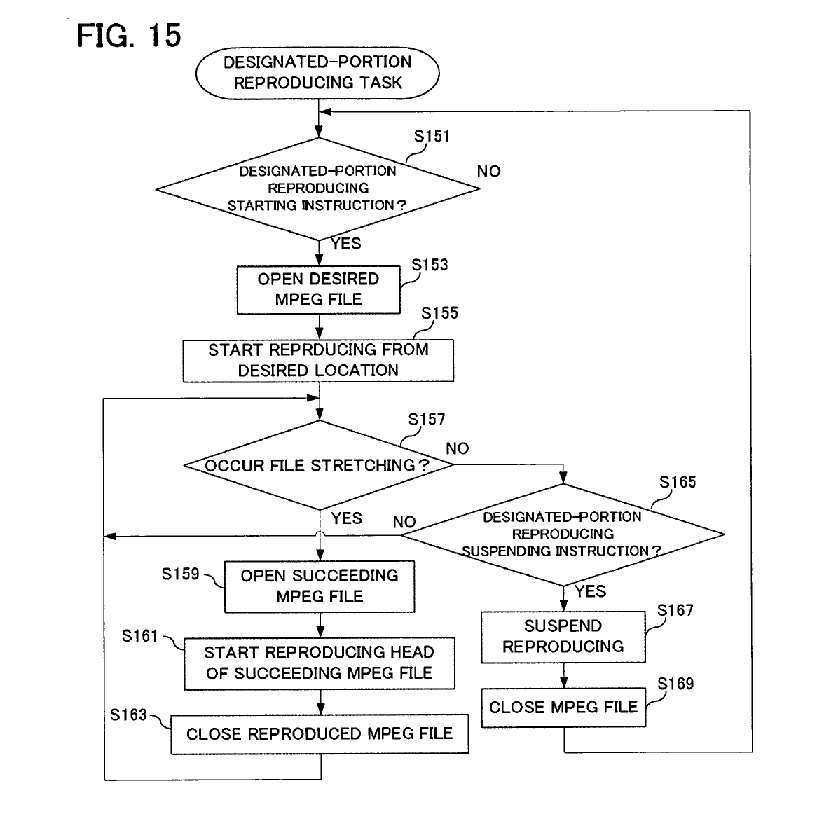

The CPU 50 is possible to execute a multi-task OS such as a uITRON, and executes a main task shown in FIG. 8-FIG. 12, a normal recording task shown in FIG. 13-FIG. 14, and a designated-portion reproducing task shown in the FIG. 15 in a parallel manner. It is noted that a control program corresponding to such task is stored in a ROM 52.

Firstly, referring to FIG. 8, the normal recording task and the designated-portion reproducing task are respectively started in step S1 and S3, the MPEG encoder 44 and MPEG decoder 46 are started in a step S5, and the HDD 26 is instructed to open the managing file in a step S7. In a step S9, the latest 24 bytes of the managing data included in the managing file is noticed, and the HDD 26 is instructed to read out the identifier written in the “tag” column.

The HDD 26 executes the process corresponding to the instruction from the CPU 50. If the instruction is file opening, the designated file is opened, and if the instruction is file closing, the designated file is closed. In addition, if the instruction is data writing, the designated data is written into the designated file, and if the instruction is data reading out, the designated data is read out from the designated file. However, when the HDD 26 fails in the instructed process, the error is notified from the HDD 26 to the CPU 50.

In a step S11, the identifier reading out by the HDD 26 is determined whether the REC_END is included or not. If YES, the process advances to a step S13, determining that the normal recording is normally ended. The HDD 26 is instructed to close the managing file in the step S13, and the HDD 26 is instructed to open the temporary recording-use MPEG file in a step S15. As a result, the managing file is closed, and the temporary recording-use MPEG file is opened.

In a step S17, the recording suspending location set in a register not shown is detected. The recording suspending location is the MPEG offset and the INDEX offset of the location in which the last temporary recording is suspended. In a step S19, the HDD 26 is instructed to start the temporary recording from the detected recording suspending location, and the HDD 26 is instructed to start the live reproduction in a step S21. This allows the video and the sound or voices, to which the temporary recording is recorded, to be output at the almost same time as the recording.

Upon starting the temporary recording and the live reproduction, it is determined whether a normal recording starting instruction is issued or not in a step S31, it is determined whether a normal recording suspending instruction is issued or not in a step S39, it is determined whether a designated-portion reproduction starting instruction is issued or not in a step S47, and it is determined whether a designated-portion reproduction suspending instruction is issued or not in a step S51.

When the normal recording starting operation is performed by an operation panel 54, the normal recording starting instruction is issued, and when the normal recording suspending operation is performed by the operation panel 54, the normal recording suspending instruction is issued. In addition, when the designated-portion reproduction starting operation is performed by the operation panel 54, the designated-portion reproduction starting instruction is issued, and when the designated-portion reproduction suspending operation is performed by the operation panel 54, the designated-portion reproduction suspending instruction is issued.

If YES in the step S31, the HDD 26 is instructed to suspend the temporary recording in a step S33, the MPEG offset and INDEX offset are set to the register in a step S35, and the HDD 26 is instructed to close the temporary-use MPEG file in a step S37.

If YES in the step S39, the HDD 26 is instructed to open the temporary-use MPEG file in a step S41, the last recording suspending location is detected from the register in a step S43, and the HDD 26 is instructed to start the temporary recording from this recording suspending location in a step S45.

If YES in the step S47, the HDD 26 is instructed to suspend the live reproduction in a step S49. If YES in the step S51, the HDD 26 is instructed to start the live reproduction in a step S53.

Returning to FIG. 8, unless the identifier written in the “tag” column of the managing data includes the REC_END, the process advances from the step S11 to a step S23, assuming that the last normal recording is abnormally ended by causing that the power is instantly cut off etc. In the step S23, the latest 24 bytes of the managing file is noticed, and the HDD 26 is instructed to read out the file number and INDEX offset from the columns of “file number” and “INDEX offset” of this managing data, respectively. When the file number and the INDEX offset are read out by the HDD 26, the HDD 26 is instructed to close the managing file in a step S25.

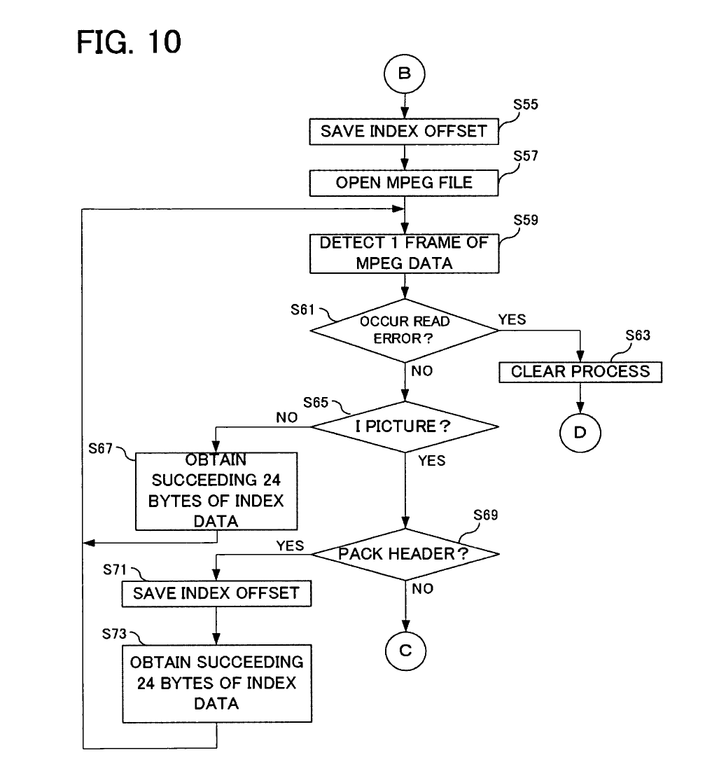

The HDD 26 is instructed to open the INDEX file corresponding to the read file number in a step S27, and the HDD 26 is instructed to read out 24 bytes of the INDEX data that starts from the read INDEX offset in a step S29. In a step S55 shown in FIG. 10, the read INDEX offset is saved to a save area (not shown).

In a step S57, the HDD 26 is instructed to open the MPEG file corresponding to the read file number in the step S23. In a succeeding step S59, the HDD 26 is instructed to read out data provided by the MPEG offset and the frame size included in the noticed INDEX data.

In a step S61, it is determined whether a read error caused by a failure of reading out data is noticed from the CPU 50 or not. If the read error is noticed, the process advances to a step S63, a clear process is executed. Specifically, the HDD 26 is instructed to update a data value of 8 Kbytes of the sector that starts from an address according to the above-mentioned MPEG offset to “0”. The data value of the noticed sector is updated to “0” by the HDD 26, therefore a error sector is restored. Upon completion of the clear process, the process advances in a step S89.

When it is succeeded that an instructed data is read out, NO is determined in a step S61. In a step S65, it is determined whether the read data is the I picture or not, and it is determined whether the pack header is included in the head of the read data or not in a step S69. It is noted that the determination in the step S65 depends on the frame type included in the noticed INDEX data.

If NO in the step S65, the HDD 26 is instructed to read out the succeeding 24 bytes of the INDEX data in a step S67, and thereafter, the process returns to the step S59. If YES in a step S69, the process advances in a step S71, and the INDEX offset indicating the location in where the INDEX data noticed at present time is written is saved to the save area. Upon completion of a save process, the HDD 26 is instructed to read out the succeeding 24 bytes of the INDEX data in a step S73, thereafter the process returns to the step S59.

Therefore, unless the read error is noticed, the noticed INDEX data is advanced by each 24 bytes, and the presence of the notice of the read error is verified about MPEG data corresponding to each INDEX data. In addition, the INDEX offset saved to the save area is updated by 1 GOP.

If NO in the step S69, the process advances to the process as from a step S75, assuming that the error sector is not included in the plurality of the sectors where the MPEG data is recorded. It is noted that if NO in the step S69, then a point of discontinuous time in the MPEG data is determined. That is, it is determined the point of discontinuous time of the MPEG-PS is included in a vicinity of the MPEG offset noticed at the present time.

In the step S75, the time information included in the noticed INDEX data is set to a variable old_time. In a step S77, the HDD 26 is instructed to read out the succeeding 24 bytes of the INDEX data, it is determined whether the read error is noticed from the HDD 26 or not in a succeeding step S79. Herein, If YES, the clear process similar to the above-mentioned is executed in a step S81. That is, the HDD 26 is instructed to update the data value of 8 Kbytes of the sector that starts from a head address of the instructed 24 bytes of the INDEX data to “0”. The data value of the noticed sector is updated to “0” by the HDD 26, as a result, the error sector is restored. Upon completion of the clear process, the process advances to a step S89.

When it is succeeded that the instructed INDEX data is readout, the process advances toa step S83, and the time information included in the read INDEX data is set to a variable cur_time. In a step S85, it is determined whether a difference between the variable cur_time and the variable old_time exceeds a predetermined value or not, if NO, then the variable cur_time is set to the variable old_time in a step S87. Upon completion of the process in the step S87, the process returns to the step S77.

Therefore, unless the read error occurs, the noticed INDEX data is advanced by each 24 bytes, until the difference of the time information included in 24 bytes of the INDEX data adjacent with each other exceeds the predetermined value. When the difference of the time information exceeds the predetermined value, the process advances to the step S89, assuming that the point of discontinuous time of the INDEX data is detected.

In the step S89, the HDD 26 is instructed to read out 24 bytes of the INDEX data corresponding to the INDEX offset in the save area. In a step S91, the MPEG offset is detected from the read INDEX data. When the MPEG offset is detected, the process advances to a step S93, and the HDD 26 is instructed to close the opened MPEG file and INDEX file. As a result, the MPEG file and the INDEX file is closed.

In a step S95, the HDD 26 is instructed to open the recording information file. In a step S97, the HDD 26 is instructed to write into the recording information file the MPEG offset detected in the step 91 and the INDEX offset indicating the writing location of the noticed INDEX data. In a step S99, the HDD 26 is instructed to close the recording information file.

Next, in a step S101, the HDD 26 is instructed to suspend the temporary recording, the MPEG offset and the INDEX offset indicating the recording suspending location are set to the register in a step S103, and the HDD 26 is instructed to close the temporary recording -use MPEG file in a step S105. In a step S107, the normal recording starting instruction is issued, the HDD 26 is instructed to start the live reproduction in a step S109. Upon completion of the process in the step S109, the process advances to the step S31.

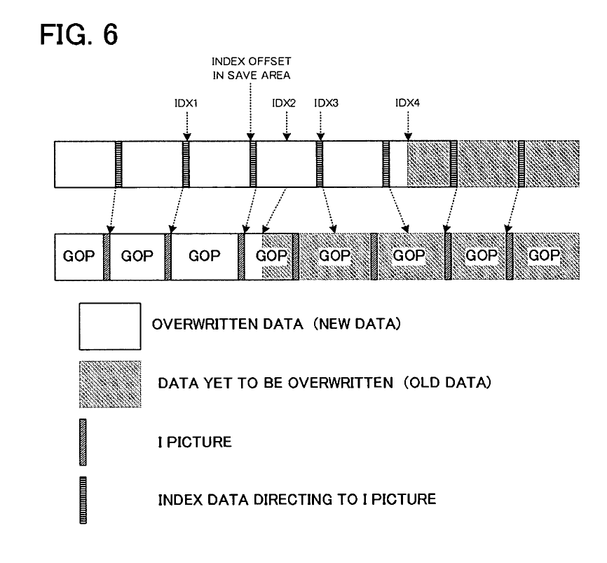

An operation when NO is determined in the step S11 will be described by referring to FIG. 6. In a case that the INDEX data obtained in the step S29 is IDX1 shown in FIG. 6, firstly the INDEX offset corresponding to the INDEX data noticed at the present time is saved to the save area in the step S55. Thereafter, the noticed INDEX data is advanced by each 24 bytes in the step S67. In addition, if a frame type information included in the noticed INDEX data is the I picture, the corresponded INDEX offset is saved to the save area in the step S71, thereafter the noticed INDEX data is advanced 24 bytes in the step S73.

When the noticed INDEX data is advanced to IDX2 shown in FIG. 6, if the read error of the MPEG-PS occurs, then YES is determined in the step S61, the clear process is executed in the step S63. The clear process is executed to 8 Kbytes based on the MPEG offset included in IDX2, as a result, the error sector is restored. In a case unless the read error is detected in IDX2, when the noticed INDEX data is advanced to IDX3, a disappearance of the pack header is detected in the step S69. The process shifts from the step S69 to the step S75. The INDEX offset remained in the save area corresponds to the INDEX data directed to the I picture at the position prior to INDX2.

Thereafter, the INDEX data is advanced by each 24 bytes in the step S77. When the noticed INDEX data is advanced to IDX4 shown in FIG. 6, if the read error occurs, then YES is determined in the step S79, and the clear process is executed in the step S81. The clear process is executed to 8 Kbytes included the noticed INDEX data. In a case unless the read error is detected in IDX4, YES is determined in the step S85 that determines the difference of the time information. As a result, updating the INDEX data is ended.

By thus operations, a head of GOP created before the recording operation is abnormally ended is specified. In addition, when the read error occurs, the clear process is conducted to the plurality of the sectors including the error sector.

The normal recording task is executed according to the flowcharts shown in FIG. 13-FIG. 14. Firstly, it is determined whether the normal recording starting instruction is issued or not in a step S111, and if YES, then the HDD 26 is instructed to read out the MPEG offset and the INDEX offset from the recording information file in a step S113. In the step S113, an opening/closing of the recording information file is also instructed. In a step S115, the HDD 26 is instructed to open the managing file, and the HDD 26 is instructed to open the MPEG file corresponding to the latest file number in a step S117.

In a succeeding step S119, the HDD 26 is instructed to write into the managing file the identifier REC_START, the recording starting time start_time, the file number fnum, the MPEG offset mofset, and the INDEX offset iofst. Upon completion of the writing, the HDD 26 is instructed to start the normal recording in a step S121. This instruction includes the INDEX offset iofst and the MPEG offset mofst. The recording of the INDEX data is started from the INDEX offset iofst, and the recording of the MPEG-PS is started from the MPEG offset mofst.

In a step S123, it is determined whether the normal recording suspending instruction is issued or not, and it is determined whether the file stretching is occurred or not, that is, the writing-destination MPEG file becomes full, in a step S125. In the step S123, if YES, the HDD 26 is instructed to suspend the normal recording in a step S127, and the HDD 26 is instructed to write into the recording information file the MPEG offset and the INDEX offset at the present time in a step S129. In the step S129, an opening/closing of the recording ending file is also instructed.

In a step S131, the HDD 26 is instructed to additionally write into the managing file the identifier REC_END and the recording ending time end_time, and the HDD 26 is instructed to close the MPEG file, the INDEX file, and the managing file in a step S133, then, the process returns to the step S111.

If YES in a step S125, the HDD 26 is instructed to additionally write into the managing file the identifier MPEG_FILE_END and the ending time end_time in a step S135, and the HDD 26 is instructed to close the MPEG file in a step S137. In a step S139, the HDD 26 is instructed to open the succeeding MPEG file, and the HDD 26 is instructed to start recording from the head of the opened MPEG file in a step S141. In a step S143, the HDD 26 is instructed to write into the managing file the identifier MPEG_FILE_START, the recording starting time start_time, the file number fnum, the MPEG offset mofst, and the INDEX offset iofst. Upon completion of writing, the process returns to the step S123.

The designated-portion reproducing task is executed according to a flowchart shown in FIG. 15. Firstly, it is determined whether the designated-portion reproducing starting instruction is issued or not in a step S151, if YES, the HDD 26 is instructed to open a desired MPEG file in a step S153. In a step S155, the HDD 26 is instructed to start reproducing from a desired location of the opened MPEG file. In a step S157, it is determined whether the file stretching is occurred or not, and it is determined whether the designated-portion reproducing suspending instruction is occurred or not in a step S165.

If YES in the step S157, the succeeding MPEG file is opened in a step S159. In a step S161, the HDD 26 is instructed to start reproducing the head of the opened MPEG file, and the HDD 26 is instructed to close the reproduced MPEG file in a succeeding step S163. Upon completion of a closing process, the process returns to the step S157. If YES in a step S165, the HDD 26 is instructed to suspend the reproducing in a step S167, and the HDD 26 is instructed to close the MPEG file in a step S169. Then the process returns to the step S151.

As understood from the above descriptions, the HDD 26 cyclically records the MPEG-PS and the INDEX data into the MPEG file and the INDEX file onto the hard disk 28. When the power is provided, the CPU 50 determines whether the last recording operation by the HDD 26 is abnormally ended referring to the managing file or not (S11). If the determination result is affirmative, the CPU 50 reads out the MPEG-PS recorded in the MPEG file by each 1 frame via the HDD 26 (S59), and reads out the INDEX data recorded in the INDEX file by each 24 bytes via the HDD 26 (S77).

When a failure of the reading operation causes by the sector error formed in the HDD 26, the clear process is executed by the CPU 50 (S63, S81). Thus, the sector error is restored. On the other hand, if the reading operation succeeds, the point of discontinuous time in the MPEG-PS or the INDEX data is detected by the CPU 50 (S69, S85). If the error sector is restored or the point of discontinuous time is detected, the normal recording of the HDD 26 is started.

Although the present invention has been described and illustrated in detail, it is clearly understood that the same is by way of the schematic diagram and example only and is not to be taken by way of limitation, the spirit and scope of the present invention being limited only by the terms of the appended claims.

What is claimed is:

1. A content recording apparatus, comprising:
a recorder for recording the content into a recording medium;
a determiner for determining whether last recording operation by said recorder was abnormally ended or not, when the power is provided;
a reader for reading each a predetermined amount of the content recorded in the recording medium, when a determination result of said determiner is affirmative;
a repairer for repairing an error of the recording medium, when said reader failed the reading operation caused by the error;
a searcher for searching a point of discontinuous time of the content recorded in the recording medium, when said reader succeeded the reading operation; and,
a starter for starting said recorder in response to either a completion of a repairing operation by said repairer or a detection of the point of discontinuous time by said searcher.

2. A content recording apparatus according to claim 1, further comprising:
a setting controller for setting a specific identifier in a first state when a recording starting instruction is issued, and the specific identifier in a second state when a recording suspending instruction is issued;
wherein said determiner conducts a determination operation referring to the specific identifier, said recorder conducts a recording operation for a period from issue of the recording starting instruction to issue of the recording suspending instruction.

3. A content recording apparatus according to claim 1, wherein the recording medium includes a plurality of a unit record area where of each is composed of a prescribed size,
said repairer updates a data value recorded in the unit record areas to a prescribed value, and a total size is exceed the predetermined amount.

4. A content recording apparatus according to claim 1, wherein the content includes a plurality of frames of a coded image, and each frame has a prescribed array,
said reader includes an image reader for reading each of the plurality of frames of the coded image,
said searcher includes an image searcher for searching the point of discontinuous time based on the array of the coded image read by said image reader.

5. A content recording apparatus according to claim 4, wherein the plurality of frames of the coded image can include a different size in each frame.

6. A content recording apparatus according to claim 4, wherein the content includes a plurality of an index data allocated in the plurality of frames of the coded image respectively,
said reader includes an index reader for reading each of a plurality of the index data,
said searcher includes an index searcher for searching the point of discontinuous time based on the index data read by said index reader.

7. A content recording apparatus according to claim 6, wherein each of the plurality of the index data includes time information,
said index searcher includes a comparator for comparing a difference of the time information which included in two adjoining index data with a threshold value.

8. A content recording apparatus according to claim 6, wherein the plurality of the index data include a standard index data intermittently,
said index reader further comprises a maintainer for maintaining temporarily location information indicating a record position of the standard index data read by said index reader.

9. A content recording apparatus according to claim 8, wherein the plurality of frames of the coded image is an image data coded in MPEG format,
the standard index data is allocated at a front of frame of GOP.

10. A content recording apparatus according to claim 8, further comprising:
a calculator for calculating a record beginning location of said recorder based on the latest location information maintained by said maintainer.

11. A computer readable recording medium encoded with a recording control program for performing the step of:
(a) recording content into the recording medium in response to a recording order;
(b) determining whether last recording operation was abnormally ended or not, when a power is provided;
(c) issuing a reading instruction for reading each a predetermined amount of the content recorded in the recording medium, when a determination result of said step (b) is affirmative;
(d) issuing a repairing instruction for repairing a error of the recording medium, when a reading operation based on the reading order issued by said step (c) failed as a result of the error;
(e) searching a point of discontinuous time of the content recorded in the recording medium, when the reading operation based on the reading instruction issued by said step (c) succeeded; and
(f) issuing the recording instruction in response to either a completion of a repairing operation based on the repairing instruction issued by said step (d) or a detection of the point of discontinuous time by said step (e).

12. A computer according to claim 11, further performing the step of:
(g) setting a specific identifier in a first state when a recording starting instruction is issued, and the specific identifier in a second state when a recording suspending instruction is issued;
wherein said step (b) conducts a determination operation referring to the specific identifier, said step (a) conducts a recording operation for a period from issue of the recording starting instruction to issue of the recording suspending instruction.

13. A content recording method, comprising the step of:
(a) recording content into a recording medium in response to a recording order;
(b) determining whether last recording operation was abnormally ended or not, when a power is provided;
(c) issuing a reading instruction for reading each a predetermined amount of the content recorded in the recording medium, when a determination result of said step (b) is affirmative;
(d) issuing a repairing instruction for repairing a error of the recording medium, when a reading operation based on the reading order issued by said step (c) failed as a result of the error;
(e) searching a point of discontinuous time of the content recorded in the recording medium, when the reading operation based on the reading instruction issued by said step (c) succeeded; and
(f) issuing the recording instruction in response to either a completion of a repairing operation based on the repairing instruction issued by said step (d) or a detection of the point of discontinuous time by said step (e).

14. A content recording method according to claim 13, further comprising the step of:
(g) setting a specific identifier in a first state when a recording starting instruction is issued, and the specific identifier in a second state when a recording suspending instruction is issued;
wherein said step (b) conducts a determination operation referring to the specific identifier, said step (a) conducts a recording operation for a period from issue of the recording starting instruction to issue of the recording suspending instruction.
